(19) United States
(12) Patent Application Publication
(10) Pub. No.: US 2003/0187579 A1
(43) Pub. Date: Oct. 2, 2003

(54) Method for predicting the formation of mould fungi

(76) Inventors: Klaus Sedlbauer, Holzkirchen (DE); Martin Krus, Munich (DE)

Correspondence Address: D Edward Dolgorukov, Marshall & Melhorn, Four Seagate 8th Floor, Toledo, OH, 43604, US

(21) Appl. No.: 10/398,046

(22) PCT Filed: Jul. 17, 2002
(86) PCT No.: PCT/EP02/07951

(30) Foreign Application Priority Data
Aug. 2, 2001 (DE) 101 37 889.0

(51) Int. Cl. G06F 19/00

(52) U.S. Cl. 702/3

(57) ABSTRACT

The invention relates to a method for predicting the formation of mold fungus, and to the uses of said method for optimizing buildings and construction products, or food products or the like. The inventive method is characterized in that biological germination conditions or growth conditions for at least one mold fungus, which are determined experimentally or by a computer, are compared with the hygrothermic conditions on an object to be examined, said hygrothermic conditions also being determined experimentally or by a computer. Based on the data obtained, it is determined whether the germination conditions or the growth conditions are obtained on said object.

This invention relates to a method for the prediction of mold fungus formation and its applications to the optimization of structures and construction products, as well as of foods and similar items.

Mold fungus infestation, in particular on the interiors of exterior construction components, but also at points on and inside said components, has recently been the subject of much discussion. The elimination or prevention of mold fungus formation not only entails significant cleaning and restoration costs, but mold fungus formation can also be hazardous to the health of the inhabitants. Of course one possibility is to reduce mold fungus infestation in indoor areas or to prevent it for a certain length of time by the application of biocides or similar agents. However, these products may also be hazardous to human health. To prevent mold fungus formation in buildings and other structures, therefore, a prevention strategy must be developed which begins by taking into consideration the requirements for the growth of mold fungus as well as the complex fluctuating physical conditions affecting the structure or item in question.

It has been determined that the growth of mold fungi requires the simultaneous presence of three essential requirements for growth, i.e. “temperature, moisture and substrate”, for a determined period of time. The applicable technical literature generally cites only a single criterion, which is the relative humidity. Recently, there have also been indications concerning relative humidity as a function of the temperature above which the formation of mold fungus can occur. As a rule, however, these characteristics cannot be used as the basis for a differentiation of the influence of the substrate, construction material or dirt and contamination. The current conventional evaluation methods for the formation of mold fungus do not allow the consideration of fluctuating boundary conditions, or allow fluctuating boundary conditions to be taken into consideration only indirectly.

On the basis of this prior art, the object of this invention is therefore to make available a method and applications of such methods by means of which the formation of mold fungus on or in an object can be reliably predicted.

This object is achieved by the method disclosed in claim 1 as well as the applications of this method as disclosed in claim 15. Advantageous developments of the method taught by the invention are disclosed in the corresponding dependent subclaims.

The biohygrothermal method taught by the invention makes it possible to predict mold fungus formation on the basis of the three above mentioned biological requirements for the growth of mold fungus, namely temperature, moisture and the substrate, given fluctuating boundary conditions. The method taught by the invention can be used for all types of components and construction materials including wood, but can also be used, for example, to predict the formation of mold fungus on foods. The method thereby consists of two steps, one based on the other, namely the generation of suitable isopleths and the application of these isopleths to a fluctuating biohygrothermal model of the component to be investigated. The method makes it possible to determine the spore germination times and the mycelium growth, whereby the influence of the substrate is also taken into consideration for the prediction of the mold fungus formation. The isopleth system thereby describes the hygrothermal growth requirements of a mold fungus and consists of a system of curves, called the “isopleths”, as a function of the temperature and the relative humidity which identify spore germination times for the prediction of spore germination and the amount of growth per unit of time for the description of mycelium growth.

Because there are significant differences in the isopleth system between individual species of mold fungus, in the development of the isopleth system that is used in the method taught by the invention for construction materials, the only mold fungi taken into consideration are those that occur in buildings and are hazardous to human health. For the approximately more than 150 species that satisfy both criteria, quantitative data were prepared in the form of isopleths for the growth parameters temperature and moisture. To make a distinction between the phases in the life cycles of the mold fungi, the isopleths are presented separately for spore germination and for mycelium growth. It is advantageous to also make a differentiation among mold fungi on the basis of the threat to human health they represent, in the form of hazard classes, which can advantageously be defined as follows:

A. Mold fungi or metabolites are significant health hazards and may not be permitted to occur in a residence.

B. Mold fungi or metabolites are hazardous to health (i.e. pathogenic) in the event of long-term exposure in enclosed spaces or have an allergenic potential.

C. Mold fungus is not hazardous to health, although an infestation may result in economic damage.

Because in the classification of mold fungi into the three hazard classes, the values for Class C differ only insignificantly from the values for Class B, it is sufficient in the isopleth model to make a distinction only between hazard classes A and B/C. The isopleth systems are advantageously developed to evaluate the spore germination and mycelium growth, and are based, for example, on biological data acquired on the basis of measurements, and take into consideration the growth requirements of all the mold fungi of a respective hazard class. The resulting lower limits of potential mold fungus activity are termed the LIM (Lowest Isopleth for Mold fungus). For this purpose, first the growth requirements of mold fungi are indicated for the hazard classes as a function of temperature and relative humidity for optimal nutrient media or substrates. To be able to take the influence of the substrate into consideration, i.e. the influence of the substrate or any substrate contaminants that may be present, it is advantageous to propose isopleth systems for two substrate groups (limit curve LIM_{BAU}) (BAU=Structure) which have been determined on the basis of experimental tests.

For the preparation of isopleth systems for different substrate groups, it is advantageous to consider the following four substrate groups which correspond to different substrates:

| | |
|---|---|
| Substrate Group 0: | Optimal nutrient media (e.g. solid |
| | media) |
| Substrate Group I: | Biologically exploitable substrates, |
| | such as carpets, plasterboard, |
| | construction products made of easily |
| | decomposable raw materials, and |
| | material for permanently elastic |
| | joints, for example, |
| Substrate Group II: | Construction materials with porous |
| | structures, such as plasters, mineral |
| | construction materials, as well as |
| | many woods and insulating materials |
| | that do not fall under Substrate |
| | Group I, |
| Substrate Group III: | Construction materials that cannot be |
| | decomposed and do not contain |
| | nutrients. |

It is therefore sufficient to have a unique isopleth system only for the groups designated 0, I and II, whereby for the substrate Group 0, the isopleths are valid for optimal nutrient media. The Substrate Group 0 is assumed for foods such as bread, for example. For the Substrate Group III, no isopleth system is necessary, because it can be assumed that without contamination, mold fungus formation cannot occur. In the event of severe contamination of the media of the Substrate Groups II and III, the Substrate Group I must always be used as a basis. In principle, in the method taught by the invention, therefore, for the determination of the relevant substrate group, the process should also begin with the least favorable case, i.e. the method must always be applied to be on the safe side with respect to the prevention of mold fungi.

Four isopleth systems each were advantageously developed for spore germination and mycelium growth, which are valid for an entire group of mold fungi, and in addition to optimal nutrient media also take different substrates into consideration, namely:

a) Isopleth systems for Hazard Class B/C (LIM B/C). These systems relate to biological solid media as nutrient media and therefore have the least demanding growth requirements of all isopleth systems, i.e. the lowest values for relative humidity. They form the growth limit for all the mold fungi that occur in buildings. That means that mold fungus formation in Hazard Class A can be excluded, i.e. A+B+C, if the growth requirement for Class B/C is not satisfied.

b) Isopleth systems for Hazard Class A (LIM A). Analogous to a), these systems are valid only for all fungi of Hazard Class A.

c) Isopleth systems for Substrate Group I (LIM_{BAU} I). Apply for all mold fungi that occur in buildings and do not apply for solid media, but to materials in Substrate Group I as substrate,

d) Isopleth systems for Substrate Group II (LIM_{BAU} II). Analogous to c), only for all materials that correctly fall into Substrate Group II.

An innovative biohygrothermal model was developed to be able to describe the effect of the significant factors on the germination of spores, namely the amount of moisture that is available at certain temperatures, in terms of construction physics. This model makes it possible to mathematically determine the moisture balance of a spore as a function of fluctuating boundary conditions, i.e. to also take into consideration the drying of the fungus spores as a function of time. The basic idea behind this fluctuating biohygrothermal method is that a fungus spore, on account of the materials present in it, has a certain osmotic potential, by means of which water can be absorbed from the environment. This potential is described mathematically by means of a moisture storage function. The absorption of moisture by the spore through the spore wall is measured in the model by means of a diffusion function.

This simplification is justified because the absorption of moisture is always isothermal on account of the small geometric size of the mold fungus spores. For the spore wall, a moisture-dependent S_{d} value is thereby used, which was determined by a comparison of the calculated spore germination times set in these isopleth systems. If a defined water content is present in the interior of the spore which permits the beginning of the metabolic process, the fungus can then regulate its metabolism itself regardless of external conditions. In the preceding method, however, the critical water content (limit water content) above which the biological activity begins may not be exceeded at all. This limit water content is determined by means of the isopleth systems described above, in which the lowest relative humidity at which spore germination occurs can be read from the corresponding LIM curves as a function of the temperature. By means of the moisture storage function defined for the interior of the spore, the resulting water content in the spore can then be calculated and compared with the limit water content.

To take potential substrate influences into consideration, the S_{d} values of the spore wall and the moisture storage function can be adjusted so that the spore germination times determined under stationary conditions with the biohygrothermal model taught by the invention equal those in the isopleth systems of Substrate Groups 0, I and II. As a result of this adaptation, a model spore that is valid for all three substrate groups can be defined. Furthermore, the LIM curves can be used in the isopleth systems of the corresponding substrate groups for the definition of the limit water content as a function of the substrate.

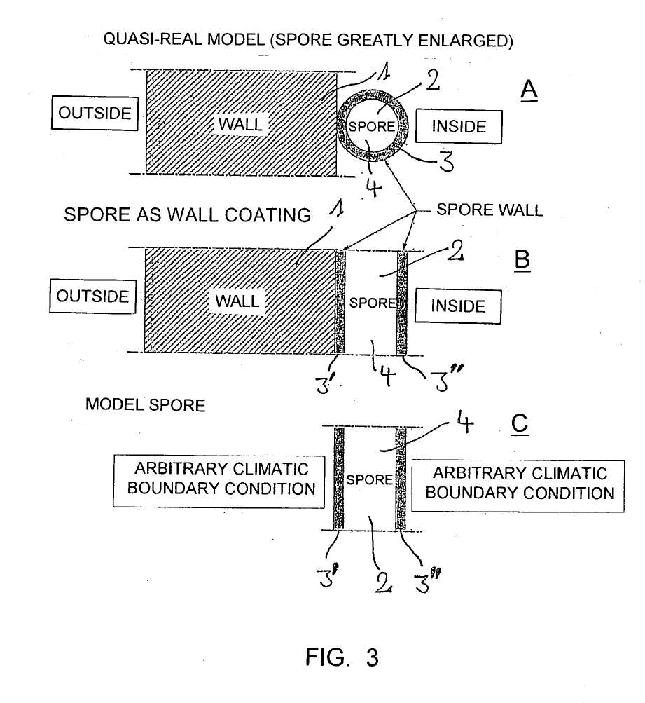

The invention teaches that the fluctuating conditions for temperature and relative humidity that occur during construction are determined by means of a calculation method for the determination of the fluctuating thermal and moisture transport for one-dimensional and two-dimensional construction geometries or are derived from measurements. The spore germination is thereby evaluated on the basis of the micro-climate that occurs on the surface. FIG. 3 shows a quasi-real spore on an enlarged scale.

FIGS. 3A to C show the wall 1 on which the mold fungus spore sits and for which the risk of mold fungus formation is being investigated. The spore 2 has a spore wall 3 and a spore interior 4. The model spore walls 3′ and 3″ are illustrated in FIGS. 3B and 3C.

The spore 2 can be imagined in the form of a sphere with a spore wall 4. The real spore is in contact with the construction material 1, i.e. the hygrothermal boundary conditions on this surface influence the moisture processes in the spore 2. However, the spore 2, on account of its small size, certainly does not affect the physical boundary conditions of the structure in the vicinity of the surface 1 of the construction material. It therefore does not make sense to model the entire process, i.e. the construction structure with the spore 2 as a wall covering, as shown in FIG. 3B. A computer model of this type with the spore 2 as a layer in front of a component 1 would in fact lead to erroneous results, because the spores 2 would represent an additional high and unrealistic diffusion resistance. Therefore, the spores 2, as shown in the bottom portion 3 are advantageously assumed to be independent of the wall 1. Therefore any desired temperature and moisture curves can be used as climatic boundary conditions for the biohygrothermal models.

The method taught by the invention now makes available a planning instrument to predict the formation of mold fungus which can be used by construction physics specialists and by consulting engineers who work in the construction sector. It can thereby be used to design construction products and ventilation systems. The method taught by the invention can also be used for planning services for remediation and cleanup measures and for their correct execution. It also becomes possible, by using this method, to make evaluations regarding the optimal operation of ventilation systems and to achieve the optimal operation of such ventilation systems. The method taught by the invention can thereby be used to predict the formation of mold fungi that can occur both on interior wall surfaces (facing the enclosed space), in the interior of the component itself and in ventilation ducts or on exterior facades.

One advantage of the method taught by the invention is that for the first time it is possible to make a prediction regarding the formation of mold fungus under fluctuating conditions. The mathematical prediction of mold fungus formation makes it possible to respond to situations that up to now could not be dealt with either with simple estimates or even with complex and time-consuming measurement techniques. For example, the experimental determination of the hygrothermal behavior of remediated exterior wall structures and the evaluation of the risk of a recurring microbial infestation after the remediation was previously impossible. Parameter studies for the selection of the correct construction materials and methods can now be done relatively easily using the method taught by the invention. Furthermore, the evaluation of internal portions of the construction has also been made easier. During the planning of construction projects or during remediation measures for the future, it is precisely these easy and economical features that make possible a broad range of applications of the new method for the prediction of mold fungus formation.

Several examples of the method claimed by the invention and their applications are described in greater detail below.

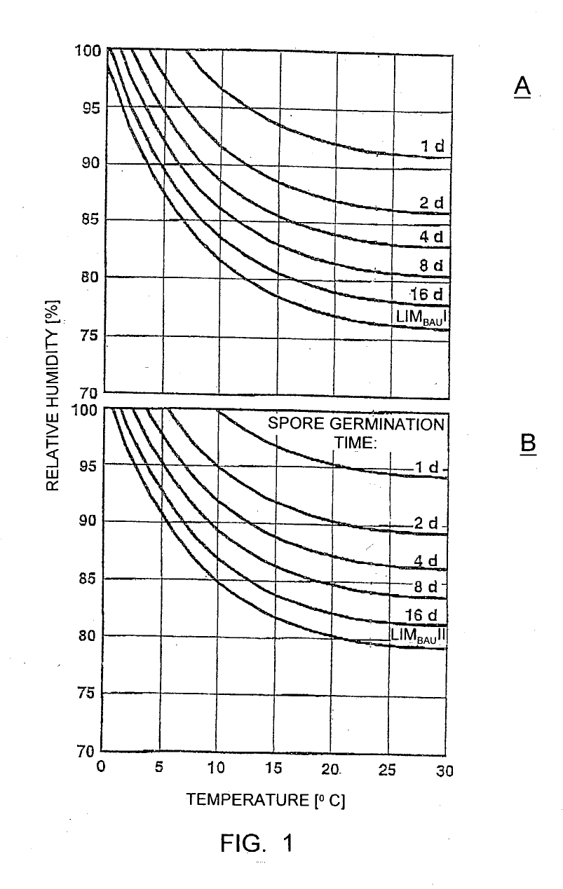

FIG. 1 shows in Sections A and B the isopleth systems for spore germination for all fungi of the substrate groups I (FIG. 1A) and II (FIG. 1B);

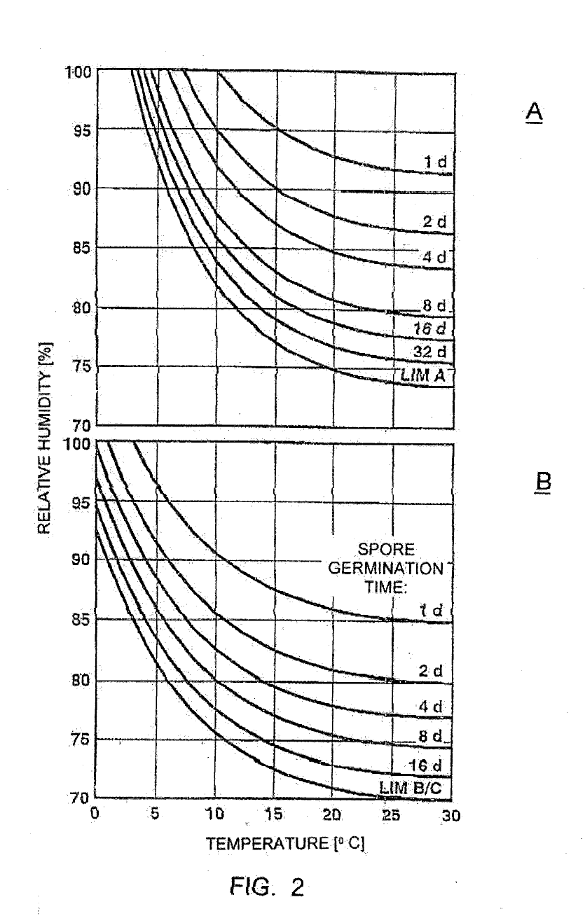

FIG. 2 shows the isopleth system for the spore germination times for all fungi in Hazard Class A (FIG. 2A) and B/C (FIG. 2B);

FIG. 3 shows various spore models;

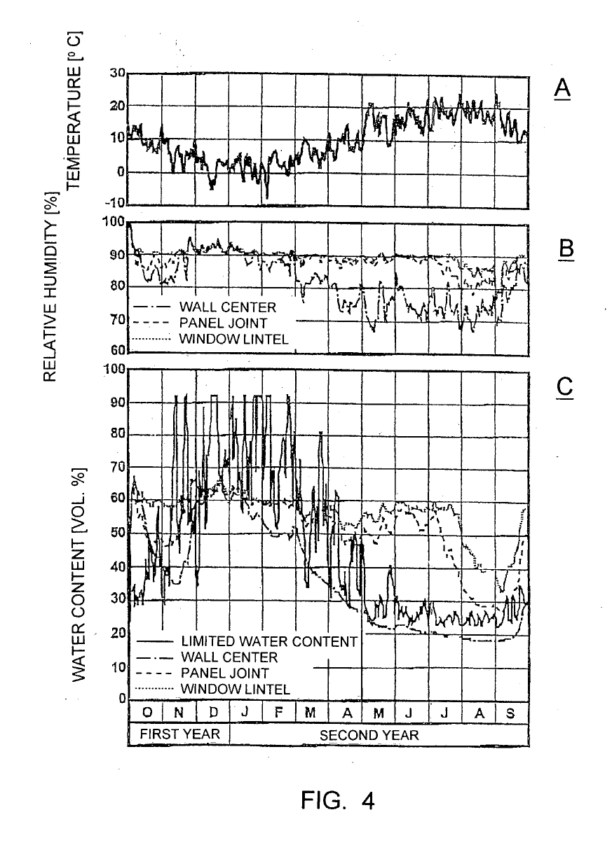

FIG. 4 shows the curves for temperature (FIG. 4A) and relative humidity (FIG. 4B) calculated as a function of time and of the spore water content (FIG. 4C) at various points of the exterior plastering of an outside wall.

FIG. 1 shows, in Sections A and B, a generalized isopleth system for spore germination which applies for all fungi of Substrate Group I (FIG. 1A) and II (FIG. 1B). The information in days thereby indicates the spore germination times. Underneath the curve identified as LIM_{BAU} are the construction materials of the corresponding group that have no biological activity, i.e. no spore germination.

FIG. 2 shows, in its individual sections, a generalized isopleth system for the spore germination which is valid for all fungi in Hazard Classes A (FIG. 2A) and B/C (FIG. 2B). The position of the curve identified as LIM (Lowest Isopleth for Mold fungus) represents the lowest limit of biological activity in a hazard class. The indicated number of days characterizes the length of time after which the first germination occurs at the selected temperature and the selected humidity.

FIG. 3 shows a schematic comparative representation of a spore on a wall (FIG. 3A), a spore as a wall covering (FIG. 3B) and a model spore observed as taught by the invention (FIG. 3C).

The ratio between spore diameter to wall thickness (30 cm) is approximately 1:100,000. The real spore is in contact with the construction material, i.e. the hygrothermal boundary conditions on this surface influence the moisture absorption processes in the spore. However, on account of its small size, the spore does not influence the physical boundary conditions in the vicinity of the surface of the construction material. Therefore the model used is not a total system simulation, based on the component structure with the spore as a wall covering (FIG. 3B), but a “model spore” which is independent of the wall (FIG. 3C). Therefore any desired curves of temperature and relative humidity can be taken into consideration as the climatic boundary conditions in biohygrothermal calculations.

FIG. 4 shows, by way of example, curves calculated for temperature (FIG. 4A) and relative humidity (FIG. 4B) as a function of time, as well as the curve of the spore water content (FIG. 4C) at various points of the exterior plastering of an outside wall. The calculations were thereby based on the following data and boundary conditions:

The wall construction is made of ETICS on concrete as the constituent elements of the wall. The measurement points investigated were an undisturbed area without any mold fungus infestation, a butt joint between ETICS panels with mold fungus infestation and a window lintel with mold fungus infestation. FIG. 4C also shows the curve of the limit water content. This figure is valid for all points on the wall and indicates the time the spore germination occurs.

This figure illustrates the situation on the exterior facades of a house which was constructed in the period comprising summer and fall. Biological growth became apparent after a short time. A superficial mold fungus infestation became visible (significant discoloration) above all in the vicinity of the window lintel. The infestation patterns in the areas in the center of the wall were primarily circular in shape. At these points, the insulation panels, which were made of hard polystyrene foam, were not installed with their edges in contact with one another, but with a gap of approximately three millimeters remaining between them. This gap was open to the underlying concrete. The circular mold fungus infestation was located approximately in the vicinity of the intersection of the edges of four insulation panels.

For an evaluation of mold fungus formation, the moisture balance in the vicinity of the window lintels and of the air gap between the insulation panels was determined. FIG. 4 shows, for the first year, the curve of the temperature (FIG. 4A) and of the relative humidity in the exterior plaster (FIG. 4B) at the location of the butt joint between the panels (broken line) and of the window lintel (dotted line) compared to the plaster in the undisturbed area, i.e. in the center of the wall (dot-dash line). Except during the period from mid-November to mid-January, the curves in the two different points differ significantly. While on the plaster (Substrate Class II), the relative humidity in the center of the wall, beginning at this point in time, decreases on account of the increasing temperature of the outside air and thus of the plaster (FIG. 4A), it remains approximately 90% at the location of the open space (panel butt joint) until approximately mid-July. In the area of the window lintel, there are even higher moisture levels in comparison to the open space in the plaster (not shown in FIG. 4). If we take these climatic data as boundary conditions for calculations with the biohygrothermal model, FIG. 4C. shows that the water content in the model spores located on the plaster remains approximately the same during the period from mid-November to mid-January, and otherwise registers lower values in the center of the wall. The sharp fluctuations in the curve of the limit water content are caused by the large changes in temperature on an exterior facade. The maxima of the limit water content at a temperature of approximately 0° C. correspond to the “available water saturation” of the spore and are approximately 92 vol. % regardless of the temperature.

The water content in the spores in the center of the wall, apart from the initial values of the first two weeks after manufacture, are always below the limit water content. That means that no fungal growth should occur in the center of the wall, which also agrees with observations on the actual test subject and experience from actual practice. That is not the case in the plastering in the vicinity of the window lintel and at the joints between panels. In the area of the window lintel the limit water content is exceeded in the first six weeks after the completion of the construction and beginning in April. As also observed on the test structure, there is fungal growth that covers a wide area as early as in the spring. At the joint between panels, the limit water content is exceeded to a somewhat lesser extent, which leads to a somewhat lesser infestation.

1. Method for the prediction of mold fungus formation on an object, for example a construction component, in which biological germination conditions and/or growth requirements determined experimentally and/or using a computer for one or more mold fungi are compared with the hygrothermal conditions that occur experimentally on the object and/or determined with a computer are compared, and from the comparison a determination is made whether the germination conditions and/or growth requirements are present on the object.

2. Method as claimed in the preceding claim having the following steps:
determination of the temperature and relative humidity curve on the object,
determination of the water content of a spore on the object and
determination whether the water content of the spore over time reaches or exceeds the water content (limit water content) required for germination and/or growth.

3. Method as claimed in one of the preceding claims, characterized by the fact that for the determination of the necessary water content, at least one system of isopleths is defined regarding germination and/or growth of mold fungi as a function of temperature and humidity.

4. Method as claimed in the preceding claim, characterized by the fact that a system of isopleths is defined for each individual fungus species or for a plurality of the following fungus species together:
a) all fungi, b) fungi that occur in buildings and are hazardous to health.

5. Method as claimed in one of the preceding two claims, characterized by the fact that a system of isopleths is determined for each individual fungus species or for a plurality of the following fungus species listed below:
a) fungi that are themselves hazardous to health or the metabolites of which are hazardous to health and can occur in a residential space, b) fungi that are themselves hazardous to health or the metabolites of which are hazardous to health in the event of long-term exposure in spaces or have an allergenic potential, and c) fungi that are not hazardous to health, but the growth of which causes economic damage.

6. Method as claimed in one of the preceding three claims, characterized by the fact that a system of isopleths is determined for each individual substrate group or a plurality of the substrate groups listed below determined jointly: a) optimal nutrient media,
b) biologically exploitable substrates, c) construction materials with porous structures and
d) construction materials that cannot be decomposed and do not contain nutrients.

7. Method as claimed in one of the preceding claims, characterized by the fact that the water content of the spore is determined on the basis of the micro-climate that occurs on the surface of the spore.

8. Method as claimed in one of the preceding claims, characterized by the fact that for the determination of the water content of the spore, the spore is assumed to be independent of the wall.

9. Method as claimed in one of the preceding claims, characterized by the fact that for the determination of the water content of the spore, the passage of water vapor as the diffusion process through a spore wall is determined with a pre-determined S_{d} value.

10. Method as claimed in one of the preceding claims, characterized by the fact that the predetermined S_{d} value is determined from experimentally determined spore germination times.

11. Method as claimed in one of the preceding claims, characterized by the fact that for the determination of the water content of the spore, the osmotic potential of the spore is determined by a moisture storage function.

12. Method as claimed in one of the preceding claims, characterized by the fact that the isopleths are determined experimentally.

13. Method as claimed in one of the preceding claims, characterized by the fact that the isopleths are calculated with a computer.

14. Method as claimed in one of the preceding claims, characterized by the fact that the method is performed at least partly with a computer.

15. Application of a method as claimed in one of the preceding claims for the evaluation of the risk of mold fungus growth on or in components or other items such as food or wooden materials, as part of a structural remediation measure, for the planning of the design and manufacture of construction products and ventilation systems, for the evaluation of the ventilation requirement of buildings.
